(19) United States
(12) Patent Application Publication
(10) Pub. No.: US 2017/0059091 A1
(43) Pub. Date: Mar. 2, 2017

(54) ENERGY RECOVERY FROM REDUCTION IN PRESSURE OF A DENSE PHASE HYDROCARBON FLUID

(71) Applicant: Chevron U.S.A. Inc., San Ramon, CA (US)

(72) Inventors: Saham Sam Tafreshi, Humble, TX (US); Paul Mark Shain, Stafford, TX (US); Jen Kai Chen, Katy, TX (US)

(21) Appl. No.: 15/250,030

(22) Filed: Aug. 29, 2016

Related U.S. Application Data
(60) Provisional application No. 62/211,178, filed on Aug. 28, 2015.

(51) Int. Cl. F17C 9/04; F02C 1/02

(52) U.S. Cl. CPC F17C 9/04; F02C 1/02

(57) ABSTRACT

Disclosed are processes in which the pressure of a dense phase fluid stream containing hydrocarbons is reduced to produce a two-phase fluid stream, and energy is recovered. The process includes passing the dense phase fluid stream at a pressure greater than the cricondenbar pressure of the dense phase fluid stream through an expander where the dense phase fluid stream is expanded isentropically such that a two phase fluid stream having a pressure lower than the pressure of the dense phase fluid stream leaves the expander. The expander is coupled to a rotating mechanical power user, such that the expander drives the rotating mechanical power user. The process further includes passing the two phase fluid stream leaving the expander to a separator such that the two phase fluid stream is separated into a vapor phase stream and a liquid phase stream. The composition or quantity of liquid formed can be adjusted to control the dew point of the gas produced from the dense-phase fluid.

### FIELD

The present disclosure relates to systems and methods for recovering energy in processes handling dense phase hydrocarbon fluids. The present disclosure further relates to systems and methods for controlling the dew point of a gas.

### BACKGROUND

Hydrocarbon feedstock often arrives at a hydrocarbon processing facility by pipeline as a dense phase fluid, also referred to as a supercritical fluid. Such fluid is above the cricondentherm temperature and cricondenbar pressure and exhibits properties of both liquid and gas. The viscosity of the fluid is similar to that of a gas, but the density is similar to that of a liquid. Natural gas can arrive by pipeline at a liquefied natural gas (LNG) plant in dense phase. At or near the plant boundary, e.g., the inlet to the LNG plant, the natural gas pressure is reduced to a pressure required by the plant for operation. The dense phase fluid pressure is typically reduced by passing the fluid through let down valves. The pressure can be reduced by a few thousand pounds per square inch. Because energy is lost in the reduction of pressure of the dense phase fluid, such conventional operations are undesirably inefficient.

It would be desirable to have a process for recovering energy when reducing the pressure of a dense phase hydrocarbon fluid. It would further be desirable to have a process for controlling the dew point of the gas produced when reducing the pressure of the dense-phase hydrocarbon fluid.

### SUMMARY

In one aspect, a process is provided in which the pressure of a dense phase fluid stream containing hydrocarbons is reduced to produce a two-phase fluid stream. The process includes passing a dense phase fluid stream containing hydrocarbons at a pressure greater than the cricondenbar pressure of the dense phase fluid stream through an expander where the dense phase fluid stream is expanded isentropically such that a single phase or a two phase fluid stream having a pressure lower than the pressure of the dense phase fluid stream leaves the expander. The expander is coupled to a rotating mechanical power user, such that the expander drives the rotating mechanical power user. The process can further include passing the two phase fluid stream leaving the expander to a separator such that the two phase fluid stream is separated into a vapor phase stream and a liquid phase stream or to a fractionation column for further processing such as natural gas liquids (NGL) removal to control the dew point of the gas.

In another aspect, a system is provided for recovering energy in a plant in which the pressure of a dense phase fluid stream containing hydrocarbons is reduced to produce a two-phase fluid stream. The system includes a dense phase fluid expander having an inlet adapted to be connected to a source of dense phase fluid, a rotor, and an outlet. A rotating mechanical power user is coupled to the rotor of the dense phase expander via a mechanical drive shaft such that when the dense phase fluid expands isentropically through the expander, the rotor of the expander rotates thereby driving the rotating mechanical power user.

### DESCRIPTION OF THE DRAWINGS

These and other objects, features and advantages of the present invention will become better understood with reference to the following description, appended claims and accompanying drawings where:

FIG. 1 is a schematic diagram illustrating a process according to one exemplary embodiment.

FIG. 2 is a schematic diagram illustrating a process according to another exemplary embodiment.

### DETAILED DESCRIPTION

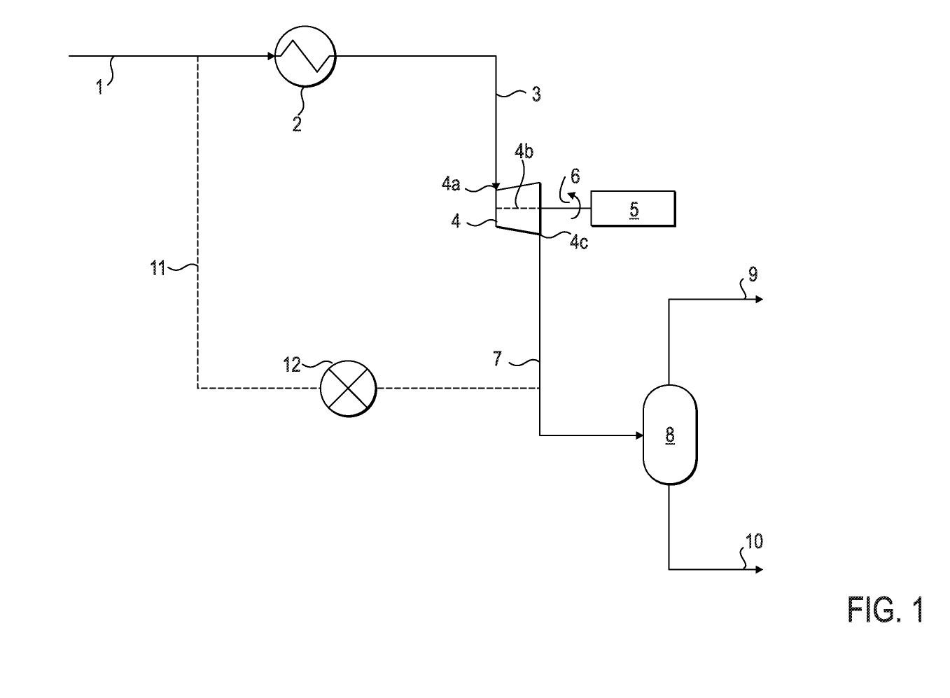

Referring to FIG. 1, in one embodiment, a process is provided for recovering energy in a plant in which the pressure of a dense phase fluid stream containing hydrocarbons is reduced to produce a two-phase fluid stream. The process includes passing a dense phase fluid stream 1 at a pressure greater than the cricondenbar pressure of the dense phase fluid stream through an expander 4 where the dense phase fluid stream is expanded isentropically such that a single phase or two phase fluid stream having a pressure lower than the initial pressure of the dense phase fluid stream leaves the expander 4.

In one embodiment, prior to passing the dense phase fluid feed stream 1 through the expander 4, the dense phase fluid stream feed 1 is passed through a preheater 2 to ensure that the dense phase fluid stream has a temperature higher than a hydrate formation temperature thereby preventing the formation of hydrates. Any suitable heater can be used as the preheater 2, including, for example, a hot oil heater.

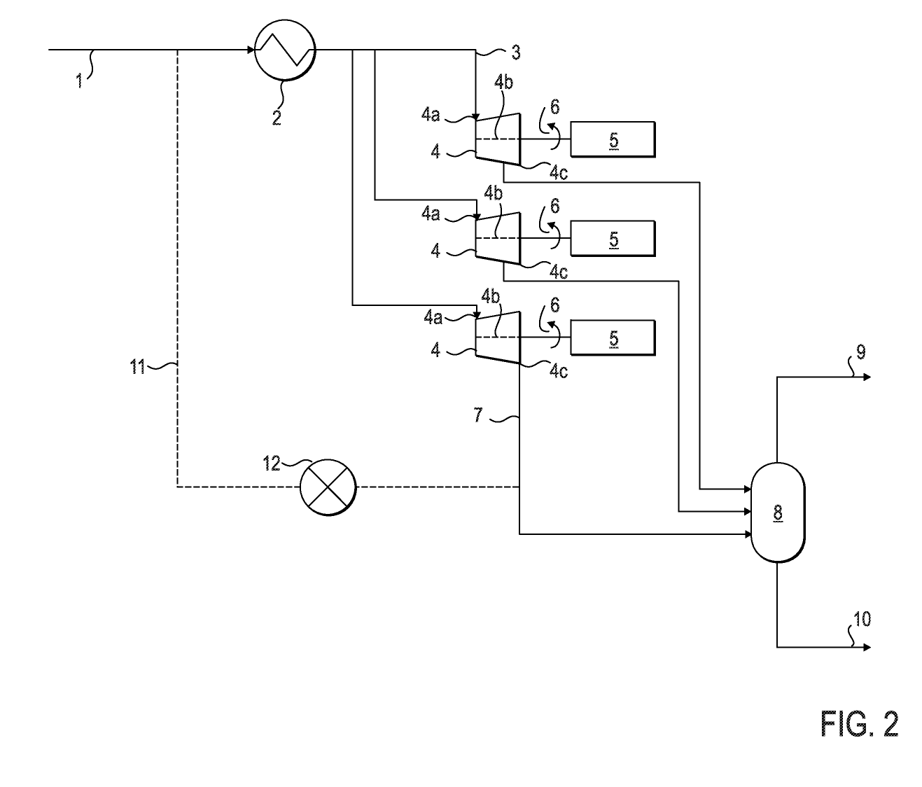

In one embodiment, as shown in FIG. 2, the dense phase fluid stream 1 is passed through a plurality of expanders 4. Each expander 4 can be coupled to a rotating mechanical power user 5. The two phase fluid stream leaving each expander can be passed to at least one separator 8.

Each expander 4 is coupled to a rotating mechanical power user 5, such that the expander drives the rotating mechanical power user 5. The rotating mechanical power user 5 can be any rotating mechanical equipment such as a generator, a pump, a compressor, or a combination thereof. The expander 4 drives the mechanical power user 5 via a drive shaft 6.

The process further includes passing the two phase fluid stream leaving the expander 4 to a separator 8 such that the two phase fluid stream is separated into a vapor phase stream 9 and a liquid phase stream 10. In one embodiment, the liquid phase stream 10 is sent to at least one fractionation column (not shown) for further processing.

By changing the amount of liquid condensed in separator 8, the dew point of the gas stream 9 can be controlled, if desired.

In one embodiment, the process can occur at the inlet to a plant for producing liquefied natural gas (LNG). The dense phase fluid feed stream 1 can be a dense phase natural gas fluid stream from a gas or oil reservoir consisting mostly of gas. Alternatively, the dense phase fluid feed stream 1 may come from a plant that processes oil and gas from reservoirs to recover oil. In some embodiments, the feed 1 can be flowing at a rate of several million to a few billion cubic feet per day. The vapor phase stream 9 leaving the separator 8 can be sent to the LNG plant (not shown) for liquefaction. In another embodiment, the process can occur within a gas processing plant other than an LNG plant which includes the handling of a dense phase fluid. The vapor phase stream 9 leaving the separator can be used in the gas processing plant as fuel gas.

In one embodiment, a system for performing the process disclosed herein includes the dense phase fluid expander 4 having an inlet 4a adapted to be connected to a source of dense phase fluid, a rotor 4b, and an outlet 4c. The system further includes the rotating mechanical power user 5 coupled to the rotor 4b of the dense phase expander via a mechanical drive shaft 6 such that when the dense phase fluid expands isentropically through the expander 4, the rotor 4b of the expander rotates thereby driving the rotating mechanical power user 5. A line 7 connects the outlet 4c of the dense phase fluid expander to a vapor-liquid separator 8.

In one embodiment, as shown in FIG. 2, the system can include a plurality of the above-described dense phase fluid expanders 4 in parallel, wherein each dense phase fluid expander 4 has an inlet 4a adapted to be connected to a source of dense phase fluid, a rotor 4b, and an outlet 4c. The system can further include a plurality of rotating mechanical power users 5 wherein each rotating mechanical power user is coupled to one of the plurality of dense phase expanders 4. The system can further include a plurality of lines 7 wherein each line 7 connects the outlet 4c of one of the plurality of dense phase fluid expanders 4 to the vapor-liquid separator 8.

In one embodiment, the system includes a bypass line 11 in fluid communication with the source of dense phase fluid and the line 7 connecting the outlet 4c of the dense phase fluid expander 4 to the vapor-liquid separator 8. The bypass line 11 has a control valve 12 therein for use in start-up, shutdown, control, or maintenance of the system. There may optionally be a heat exchanger in the bypass line 11 or the bypass line's source could be downstream of heat exchanger 2 rather than upstream of heat exchanger 2.

It should be noted that only the components relevant to the disclosure are shown in the figures, and that many other components normally part of a fluid processing system are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. In addition, “comprise,” “include” and their variants, are intended to be non-limiting, such that recitation of items in a list is not to the exclusion of other like items that may also be useful in the materials, compositions, methods, and systems of this invention.

This written description uses examples to disclose the invention, including the best mode, and to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

What is claimed is:

1. A process in which a dense phase fluid stream containing hydrocarbons is converted to a two-phase fluid stream, comprising:
passing a dense phase fluid stream having a cricondenbar pressure and containing hydrocarbons at a pressure greater than the cricondenbar pressure through an expander where the dense phase fluid stream is expanded isentropically such that a two phase fluid stream having a pressure lower than the pressure of the dense phase fluid stream leaves the expander; wherein the expander is coupled to a rotating mechanical power user, such that the expander drives the rotating mechanical power user.

2. The process of claim 1, further comprising:
passing the two phase fluid stream leaving the expander to a separator such that the two phase fluid stream is separated into a vapor phase stream and a liquid phase stream.

3. The process of claim 1, further comprising:
removing natural gas liquids from the gas to control the gas dew point

4. The process of claim 1, wherein the process occurs at the inlet to a plant for producing liquefied natural gas.

5. The process of claim 1, wherein the rotating mechanical power user comprises a generator, a pump, a compressor, or a combination thereof.

6. The process of claim 1, wherein prior to passing the dense phase fluid stream through the expander, the dense phase fluid stream is passed through a preheater to ensure that the dense phase fluid stream has a temperature higher than a hydrate formation temperature to prevent the formation of hydrates.

7. The process of claim 1, wherein the dense phase fluid stream is passed through a plurality of expanders arranged in parallel or in series; each expander is coupled to a rotating mechanical power user; and the two phase fluid stream leaving each expander is passed to at least one separator.

8. The process of claim 2, wherein the liquid phase stream is sent to at least one fractionation column for further processing.

9. The process of claim 2, wherein the vapor phase stream is sent to a liquefaction plant.

10. The process of claim 2, wherein the vapor phase stream is used as fuel gas.

11. The process of claim 1, further comprising:
passing the two phase fluid stream leaving the expander to a fractionation column for further processing.

12. A system for recovering energy in a process in which a dense phase fluid stream containing hydrocarbons is converted to a two-phase fluid stream, comprising:
a. a dense phase fluid expander having an inlet adapted to be connected to a source of dense phase fluid, a rotor, and an outlet; and
b. a rotating mechanical power user coupled to the rotor of the dense phase expander via a mechanical drive shaft such that when the dense phase fluid expands isentropically through the expander, the rotor of the expander rotates thereby driving the rotating mechanical power user.

13. The system of claim 12, further comprising:
c. a vapor-liquid separator; and
d. a line connecting the outlet of the dense phase fluid expander to the vapor-liquid separator.

14. The system of claim 12, wherein the process occurs in a liquefied natural gas production plant.

15. The system of claim 12, comprising:
a. a plurality of dense phase fluid expanders wherein each dense phase fluid expander has an inlet adapted to be connected to a source of dense phase fluid, a rotor, and an outlet; and
b. a plurality of rotating mechanical power users wherein each rotating mechanical power user is coupled to one of the plurality of dense phase expanders.

16. The system of claim 13, further comprising a bypass line in fluid communication with the source of dense phase fluid and the line connecting the outlet of the dense phase fluid expander to the vapor-liquid separator; wherein the bypass line has a control valve therein for use in start-up, shutdown, control, or maintenance of the system.
